(19) United States
(12) Patent Application Publication
(10) Pub. No.: US 2003/0147264 A1
(43) Pub. Date: Aug. 7, 2003

(54) Circuit configuration combining synchronous rectifier circuit for converter with LC snubber circuit

(76) Inventor: Masahito Jinno, Kao Hsiung Hsien (TW)

Correspondence Address: Keith Kline, PRO-TECHTOR INTERNATIONAL SERVICES, 20775 Norada Court, Saratoga, CA, 95070-3018, US

(21) Appl. No.: 10/121,969

(22) Filed: Apr. 11, 2002

(30) Foreign Application Priority Data
Feb. 1, 2002 (TW) 91101846

(51) Int. Cl. H02M 3/335

(52) U.S. Cl. 363/20

(57) ABSTRACT

A circuit configuration combining a synchronous rectifier (SR) circuit for a converter with an LC snubber circuit is characterized in that the converter includes a transformer, a secondary coil of which being connected at an end to a metal oxide semiconductor field effect transistor that is parallelly connected to a resistance and a capacitance that are serially connected to each other, in order to reduce oscillation and electromagnetic interference; and that a primary coil of the transformer is serially connected at two ends to two diodes, an inductance is connected between the two diodes, and a connection end of the inductance to one of the two diodes is connected to a junction of the transformer and a main switch via a capacitance to form the LC snubber circuit. In this way, the transformer of the converter may be reset to enable regeneration of energy and upgraded efficiency of the converter.

### BACKGROUND OF THE INVENTION

The present invention relates to a circuit configuration combining a synchronous rectifier circuit for a converter with an LC snubber circuit, and more particularly to a circuit configuration in which a converter having a synchronous rectifier is provided with an LC snubber circuit to eliminate turn-off surge on the converter and to enable reset of a transformer of the converter and, accordingly, regeneration of energy, so that the converter may have upgraded efficiency.

A general communication system requires a miniaturized and high-efficiency power-supply module to save space and energy. However, loss of output current at diodes during energizing period prevents the power-supply module from reaching a preset efficiency level. Recently, integrated circuits (IC) have been widely employed in computers and peripherals thereof for both industrial and domestic purposes. While a high-density IC apparatus provides more and better functions, its power density increases with the density of integrated circuits. To reduce loss of energy, such integrated circuits are designed to have a service voltage (that is, an output voltage of the power-supply module) as low as possible. In other words, a conventional concept that a computer should use low voltage and high current results in loss of energy at output diodes of the power supplier during energizing, as well as reduced efficiency of the power-supply module.

The only way to solve this problem is to develop an almost ideal diode that has advantages of extremely small internal resistance and extremely low cut-in voltage. However, such ideal diode is too difficult to be realized. Nevertheless, a metal oxide semiconductor field effect transistor (MOSFET) synchronous rectifier (SR) may be used to replace a conventional diode rectifier circuit. Moreover, some active clamp circuits enable further improvement of efficiency in the use of the MOSFET SR. However, such improvement involves in the use of auxiliary active switches and complicated driving circuits.

FIG. 1 shows an MOSFET SR circuit for a single-ended forward converter. The circuit includes a switch S2 that uses a FET Q1 and a parasitic diode D1 thereof FET Q2 and a parasitic diode D2 thereof as a flywheel gear. To reduce loss of energy at the diode D2 during energizing, a by-pass capacitance C1 is incorporated, as shown in FIG. 2, to extend the reset time required by a transformer of the converter, and to prevent the two FETs Q1 and Q2 from closing at the same time. However, due to a parasitic inductance presented in the converter, the capacitance C1 causes the converter to generate high-frequency oscillation that worsens the problem of electromagnetic interference (EMI) and increases loss of power.

### SUMMARY OF THE INVENTION

It is therefore a primary object of the present invention to provide an improved circuit configuration to eliminate drawbacks existing in the conventional MOSFET SR circuit for a converter. To achieve the above and other objects, the circuit configuration of the present invention mainly includes an MOSFET parallelly connected to a capacitance and a resistance that are connected in series, in order to reduce oscillation and EMI. The circuit configuration of the present invention also incorporates an LC snubber circuit to obtain high efficiency for the converter.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a circuit diagram of a conventional synchronous rectifier (SR)

FIG. 2 is a circuit diagram of another conventional synchronous rectifier (SR);

FIG. 3 is a circuit diagram of the present invention combining an MOSFET SR circuit with an LC snubber circuit;

FIG. 4 is a circuit diagram of a circuit configuration combining an MOSFET SR circuit with an RCD snubber circuit;

FIG. 5 compares two load characteristic-efficiency curves separately obtained from the circuit configurations shown in FIG. 3 and FIG. 4;

FIG. 6 compares two input characteristic-efficiency curves separately obtained from the circuit configurations shown in FIG. 3 and FIG. 4;

FIG. 7 shows waveforms of the present invention using the LC snubber circuit;

FIG. 8 shows waveforms of the present invention corresponding to different operating states of a converter thereof;

FIG. 9 shows operating states of the present invention using the LC snubber circuit;

FIG. 10 is a circuit diagram showing the present invention is used on a flyback converter with a synchronous rectifier circuit;

FIG. 11 is a circuit diagram showing the present invention is used on a half-bridge converter with a synchronous rectifier circuit;

FIG. 12 is a circuit diagram of a forward converter with a synchronous rectifier circuit, wherein the converter is provided with an energy-regenerating circuit; and

FIG. 13 is a circuit diagram of a flyback converter with a synchronous rectifier circuit, wherein the converter is provided with an energy-regenerating circuit.

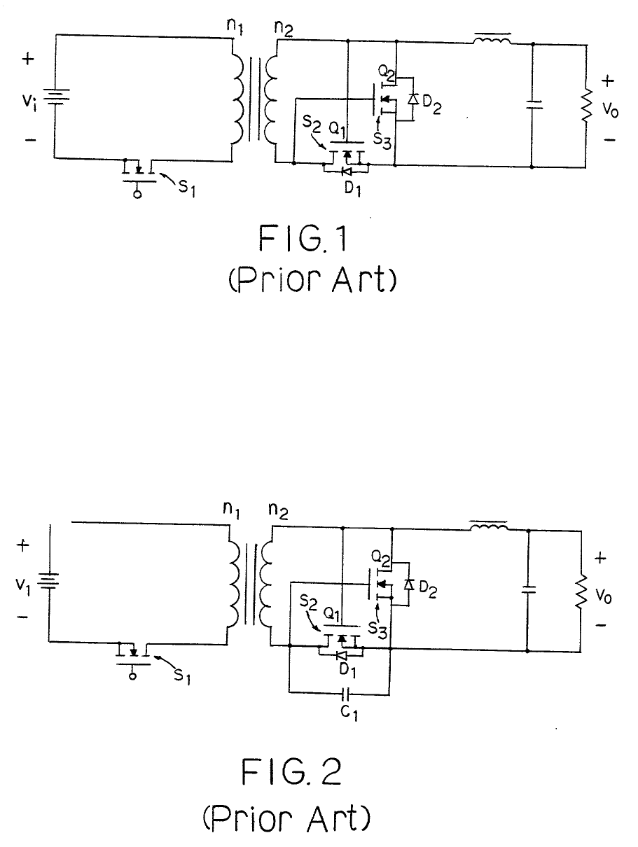

### DETAILED DESCRIPTION OF THE PREFERRED EMBODIMENTS

Please refer to FIG. 3. The present invention provides a circuit configuration that mainly includes a metal oxide semiconductor field effect transistor (MOSFET) circuit, as that shown in FIG. 1, parallelly connected to a resistance R2 and a capacitance C2 connected in series for reducing high-frequency oscillation and thereby eliminating electromagnetic interference (EMI) to upgrade efficiency of a converter, and an LC snubber circuit formed by incorporating an inductance L, a capacitance C, and two diodes D3, D4 into a primary coil of the transformer of the converter. More specifically, in the snubber circuit of the present invention, the primary coil of the transformer is connected at an end to an end of a main switch S1 while the primary coil and the main switch S1 are serially connected at another ends to the diodes D3 and D4, respectively; the inductance L is connected between the two diodes D3 and D4; and the capacitance C is connected between a connection end of the inductance L to one of the two diodes D3 or D4 (it is D3 in the illustrated drawing) and a junction of the primary coil of the transformer and the main switch element S1.

Movements of the LC snubber circuit of the present invention will now be described in more details as follows.

When the main switch S1 is open, energy presenting in magnetic inductance and leakage inductance would continuously guide current to flow through the diode D3 and the capacitance C without generating a voltage surge. And, the capacitance C discharges during this period of time. When the main switch S1 is closed, a resonance effect is produced between the capacitance C and the inductance L via the main switch S1 and the diode D4, and the capacitance C charges during this period of time. The converter is reset to eliminate turn-off surge without the need of using any auxiliary active switch.

Moreover, when the main switch S1 is open, energy-stored in the main switch S1, the converter, and passive elements of connectors would create energy regeneration.

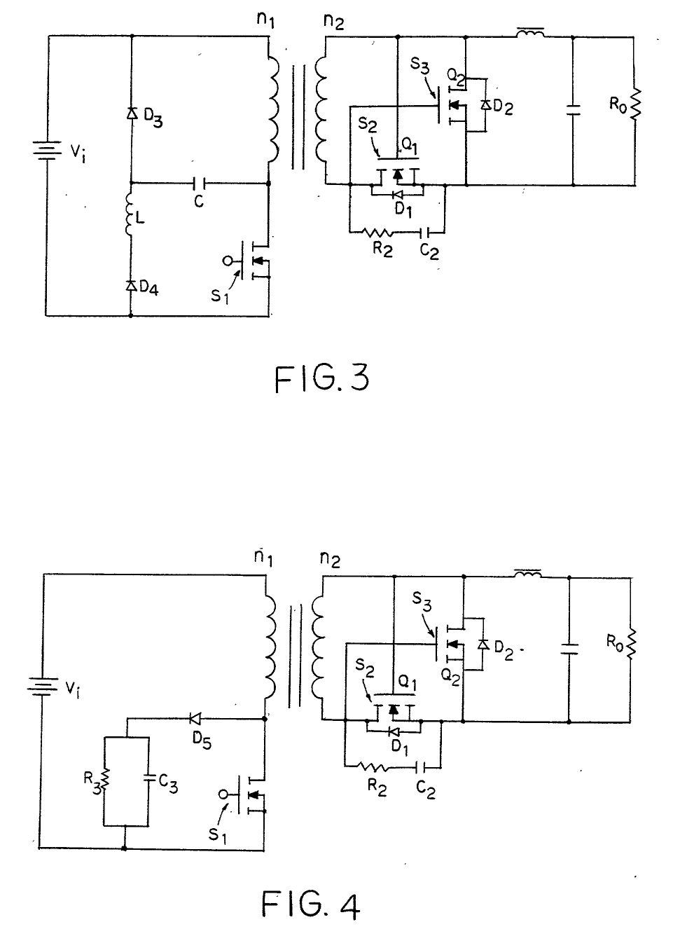

FIG. 4 shows a resistance R3, a capacitance C3, and a diode D5 are incorporated into the primary coil of the transformer of the converter to provide an RCD snubber circuit for protecting the main switch S1 against turn-off surge.

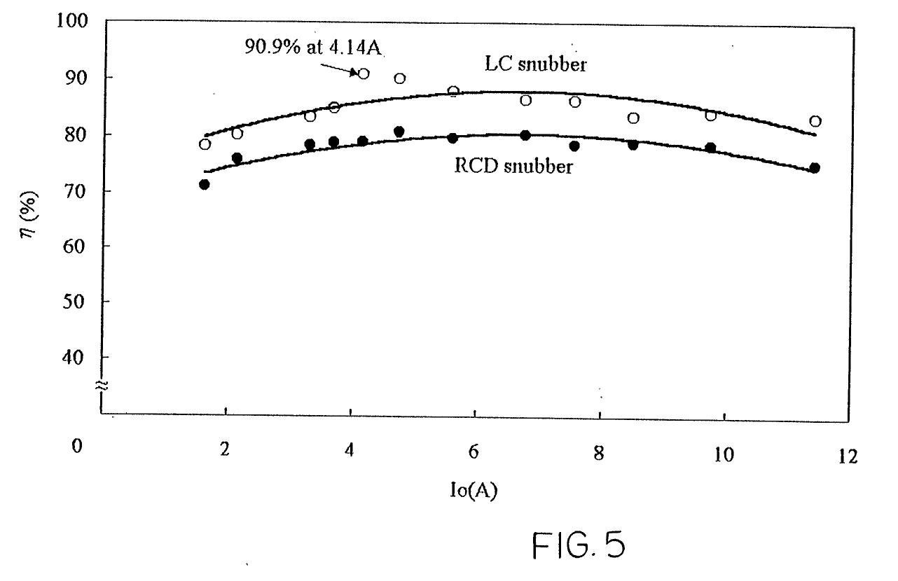

FIG. 5 compares two load characteristic-efficiency curves separately obtained from a converter using the LC snubber circuit of the present invention shown in FIG. 3 and another converter using the RCD snubber circuit shown in FIG. 4. Both converters include a MOSFET SR. It can be seen from FIG. 5 that, with the LC snubber circuit, the forward transformer reaches a maximum efficiency of 90.9% at 4.14A, which is higher than that of the forward transformer with the RCD snubber circuit.

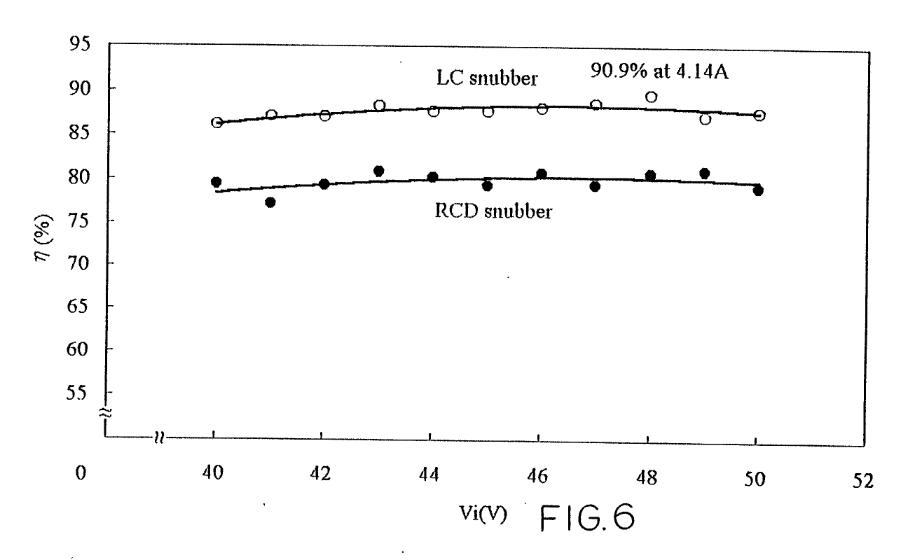

FIG. 6 compares two efficiency curves separately obtained from two transformers that are tested with different input voltages under two different conditions, that is, using the LC snubber circuit of the present invention and using the RCD snubber circuit of FIG. 4. Again, it can be clearly seen from FIG. 6 that the transformer using the LC snubber circuit has efficiency about 10% higher than that of the transformer using the RCD snubber circuit.

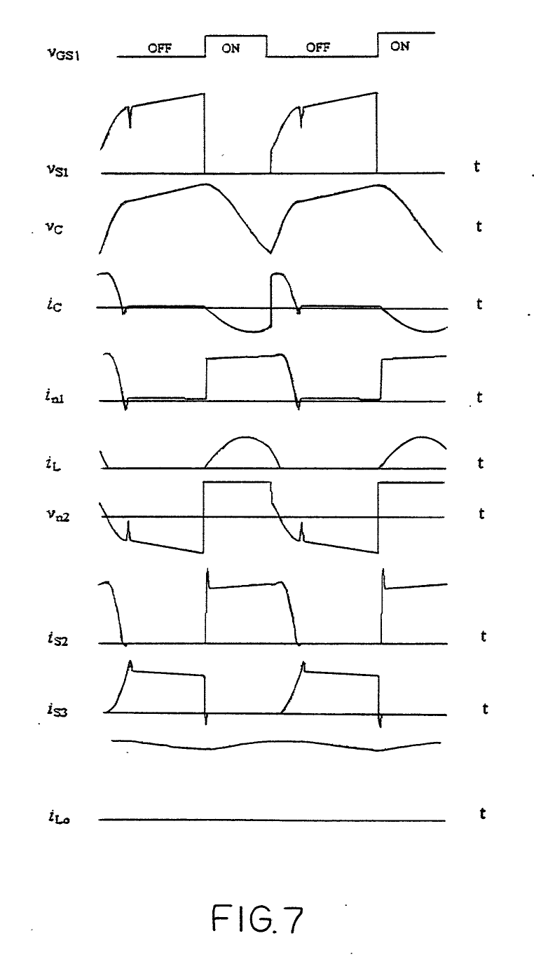

FIG. 7 shows different waveforms of the present invention using the LC snubber circuit, wherein the horizontal coordinate represents time (t) while letters V and I represent voltage and current, respectively. A main waveform thereof in rest position corresponding to one cycle of switch includes seven operating states, as shown in FIG. 8. The main switch S1 is ON in two of these seven operating states and is OFF in the other five operating states.

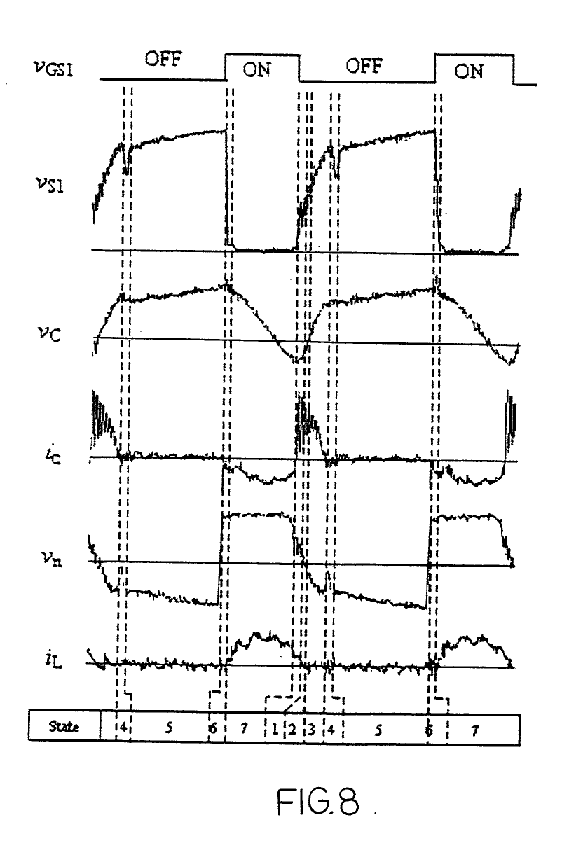

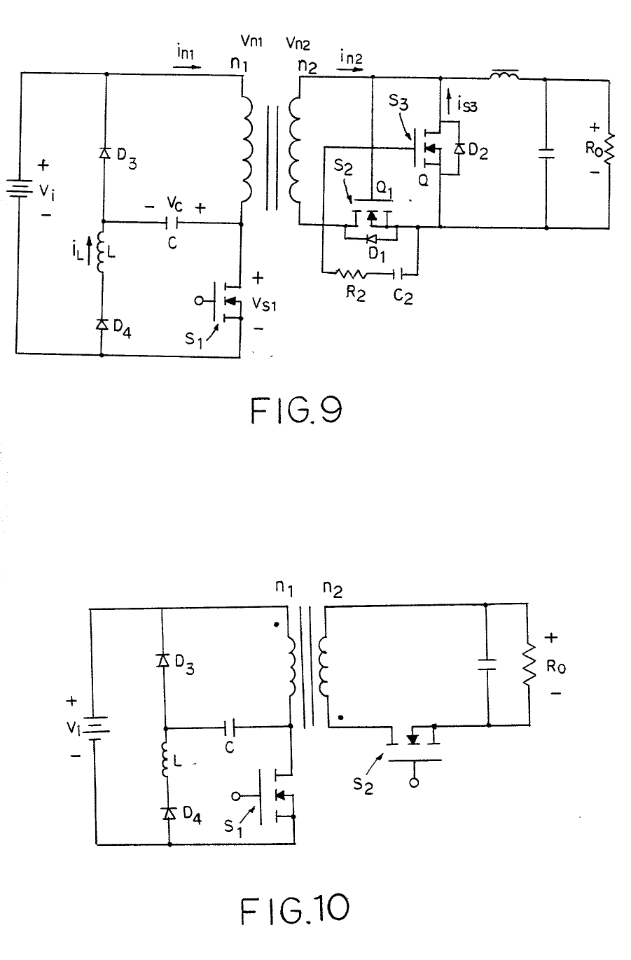

Please refer to FIG. 9. The seven operating states of the converter using the LC snubber circuit of the present invention will now be described in details as follows.

(1) State 1:

The main switch S1 is open. The capacitance C discharges due to magnetic current in the converter and the output current. Meanwhile, energy stored in the inductance L returns to a voltage source Vi. Since a pole of the capacitance C through where voltage passes is not a positive pole, the switch S2 keeps closed, and it is a secondary current of the converter that supplies power to a load resistance R₀.

(2) State 2:

This state starts when an induced current i_{L} reaches zero, and it ends when the capacitance C discharges to zero.

(3) State 3:

A primary coil current iₙ₁ continuously charges the capacitance C. When the energy is fully transferred to the capacitance C, the primary coil current iₙ₁ should be zero. At this point, a voltage Vc of the capacitance C has been charged to a specific voltage. A secondary coil voltage |Vₙ₂| gradually increases with the charging of the capacitance C. During the period of increasing the secondary coil voltage |Vₙ₂|, the switch S3 does not become ON immediately. However, the gradually increasing secondary coil voltage |Vₙ₂| makes the diode D2 at this point, and the FET Q2 of the switch S3 is opened at the same time.

(4) State 4:

The diode D3 reverses when the primary coil current iₙ₁ reaches zero. The voltage Vc of the capacitance C slightly discharges when a reverse current of the diode D3 in the State 4 recovers. Meanwhile, since a switch voltage V_{S1} is higher than the voltage source Vi, there is current flows reversely through the primary coil n1 to the voltage source Vi to therefore recover the energy. At this stage, an energy recovery time is usually longer than a reverse recovery time of the diode D3. At the end of the State 4, a value of the primary coil current iₙ₁ is reached when a primary coil voltage Vₙ₁ is zero and the switch voltage V_{S1} is equal to the voltage source Vi.

On the other hand, since the switch S3 is closed, a switch voltage V_{S2} is equal to a negative coil voltage Vₙ₂. Since a passive capacitivity of the capacitance C2 and the switch S2 may be charged by a reverse coil current iₙ₂, the reverse coil current iₙ₂ would reduce to zero at the end of the State 4.

(5) State 5:

The charged capacitance C2 may be used to extend the closed state of the FET Q2 in the switch S3. That is, the converter is reset to reduce the current to zero. As a result, a flywheel current does not flow through the diode D2 of the switch S3 to avoid a secondary reverse voltage of the converter that has big energy loss during energizing. When the primary coil current iₙ₁ reaches zero, a reverse voltage Vₙ₁ is induced to charge the capacitance C via the diode D3, causing a reverse voltage of the secondary coil voltage Vₙ₂ to rise and thereby keeps the switch S3 closed. When the diode D3 is made, the switch voltage V_{S1} is equal to a sum of the voltage Vc of the capacitance C and the voltage source Vi, and the switch voltage V_{S1} keeps lower than twice of the voltage of the voltage source Vi.

(6) State 6

When the main switch S1 is closed, current flows from the voltage source Vi to the primary coil n1 via the switch S1. Meanwhile, the diode D4 would be forward biased, the capacitance C would discharge via the switch S1 and the diode D4, and the voltage Vₙ₂ supplies power to the load resistance R₀ via the switch S2. After lapse of a very short time, a reverse flywheel current i_{S3} flows through the switch S3. At this point, the switch S2 and the switch S3 are closed at the same time.

(7) State 7:

When a reverse recovery current of the diode D2 inside the switch S3 reaches zero, the primary current keeps flowing through the primary coil n1 and the switch S1. Meanwhile, the capacitance C keeps discharging. At the secondary side, the coil voltage Vₙ₂ keeps supply of power to the load resistance R₀ and keeps reversed charge of the capacitance C via the diode D4 and the inductance L.

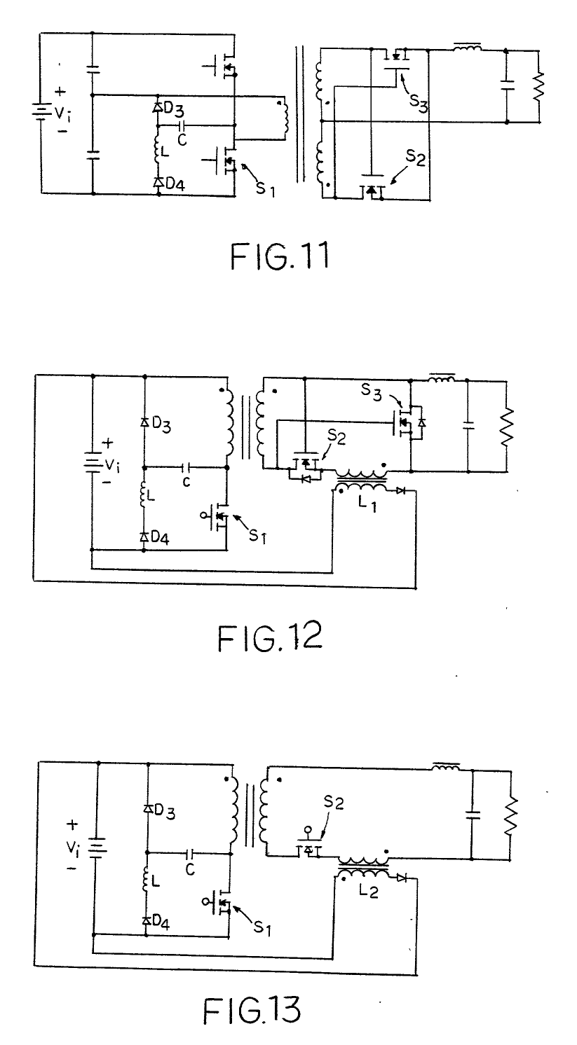

In addition to the above-described forward converter with SR, the present invention may also be used with a flyback converter as shown in FIG. 10 or with a half-bridge converter as shown in FIG. 11.

FIG. 12 shows another embodiment of the present invention, in which an additional inductance L1 having a secondary coil is incorporated. A primary coil of the inductance L1 is connected to the switches S2, S3. When the switch S2 is open, energy of possibly generated voltage surge is regenerated at the voltage source to protect the switch S2.

FIG. 13 shows a further embodiment of the present invention, in which an additional regenerating circuit is incorporated into the flyback converter shown in FIG. 10. The regenerating circuit includes an additional inductance L2 having a secondary coil. A primary coil of the inductance L2 is connected to the switch S2. When the switch S2 is open, energy of possibly generated voltage surge is regenerated at the voltage source to protect the switch S2.

The present invention has been described with some preferred embodiments thereof and it is understood that many changes and modifications in the described embodiments can be carried out without departing from the scope and the spirit of the invention as defined by the appended claims.

What is claimed is:

1. A circuit configuration comprising a synchronous rectifier (SR) circuit for a converter and an LC snubber circuit combined with said SR circuit; said converter including a transformer, a secondary coil of which being connected at an end to a metal diode semiconductor field effect transistor (MOSFET), said MOSFET being parallelly connected to a resistance and a capacitance that are serially connected to each other, in order to reduce oscillation and electromagnetic interference (EMI) a primary coil of said transformer being connected at an end to an end of a main switch; said primary coil and said main switch being serially connected at another end to first and second diodes, respectively; an inductance is connected between said first and said second diodes, and a connection end of said inductance to said first diode is connected to a junction of said primary coil of said transformer and said main switch element via a capacitance to constitute said LC snubber circuit.

2. The circuit configuration as claimed in claim 1, wherein said converter is a forward converter.

3. The circuit configuration as claimed in claim 1, wherein said converter is a flyback converter.

4. The circuit configuration as claimed in claim 1, wherein said converter is a half-bridge converter.

5. The circuit configuration as claimed in claim 1, wherein said converter enables energy regeneration.

6. The circuit configuration as claimed in claim 5, wherein said transformer of said converter is provided with an inductance having a secondary coil, said inductance being serially connected to a switch of said MOSFET, such that when said switch of said MOSFET is open, energy of possibly generated voltage surge is regenerated at a secondary side of a voltage source to protect said switch of said MOSFET.

7. The circuit configuration as claimed in claim 1, wherein said transformer of said converter has more than one output.

8. The circuit configuration as claimed in claim 2, wherein said transformer of said converter has more than one output.

9. The circuit configuration as claimed in claim 3, wherein said transformer of said converter has more than one output.

10. The circuit configuration as claimed in claim 4, wherein said transformer of said converter has more than one output.

11. The circuit configuration as claimed in claim 5, wherein said transformer of said converter has more than one output.

12. A circuit configuration comprising a synchronous rectifier (SR) circuit for a converter and an LC snubber circuit combined with said SR circuit; said converter including a transformer and being characterized in that said transformer has a secondary coil, an end of which being connected to an MOSFET, and said MOSFET is parallelly connected to a resistance and a capacitance that are connected in series.
